(19) United States
(12) Patent Application Publication
(10) Pub. No.: US 2014/0329491 A1
(43) Pub. Date: Nov. 6, 2014

(54) ProtectEM (Domestic Abuse and Emergency App)

(71) Applicant: Deann Elma Scott, St. George's (GD)

(72) Inventor: Deann Elma Scott, St. George's (GD)

(21) Appl. No.: 14/262,749

(22) Filed: Apr. 27, 2014

Related U.S. Application Data
(60) Provisional application No. 61/816,737, filed on Apr. 27, 2013.

(51) Int. Cl. H04M 1/725; H04W 4/22; H04M 11/04

(52) U.S. Cl. CPC H04M 1/72541; H04M 11/04; H04W 4/22
USPC 455/404.2; 455/404.1

(57) ABSTRACT

ProtectEM is a mobile application created to provide emergency (911) services to individuals in cases of domestic abuse, rape, kidnapping, sexual assaults, and any other form of un-provoked violence. The app can be downloaded from regular app stores to any mobile device, or can be embedded into wearable device/accessories like earrings, watches, necklaces, clothing, skin patches, or electronic tattoos etc., which can be easily activated in an emergency to alert emergency responders that the wearer is in danger and needs help. It would also beam the wearers' exact location so that responders can quickly get to the scene. The physical accessories can be configured to start taking pictures of the attacker and immediate surroundings, and/or to start recording audio (which could assist responders in understanding the nature of the attack. In case of missing persons, a friend, care-taker, or next-of-kin can remotely activate the accessory so as to assist in locating the individual quickly.

### CROSS-REFERENCE TO RELATED APPLICATIONS

ProtectEM (Domestic Abuse & Emergency Mobile App)—Provisional Application No. 61/856,734, was filed via EFS. Receipt date 21 Jul. 2013. EFS ID 16371482. This Provisional Application was filled to provide protection will preparing to file a non-provisional application for this invention.

### SEQUENCE LISTING

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Being able to contact 911 when caught in a violent or abusive situation could prove impossible depending on the place and circumstances that one is subjected to. ProtectEM mobile app functions as an emergency application that can be back-ended into a National Emergency Response system, Security Agency, or Emergency Room/Ambulance system to quickly locate and rescue victims in violent situations before the attacker can have enough time to inflict serious harm.

Victims of domestic abuse or victims of any violent attack can be in such a state of panic that it is difficult to think straight. Even if they attempt to call for help, they might be so emotionally shaken up that it might be difficult to even dial 911. Even if they do, the time needed for a responder to pick up the phone could feel like an eternity, not to mention the dexterity needed to describe their location or situation, fearing the attacker's furry and the safety of their life.

People in unprovoked violent situations need a way to call 911 and to inform their loved ones that they are in danger without the attacker's knowledge. They need a way to describe the nature of the danger and how they can be located without having to communicate it verbally. While the attacker thinks he/she is in control, he should be in for his most important surprise. The app ProtectEM, should function as a personal security alert system for the person under attack, by being able to call 911 on their behalf, when activated. ProtectEM should also be able to beam the exact location of the user to 911 responders.

This app should be able to connect to other security systems apart from 911 services. That way it can be adopted for use by government officials and other high-level officers without compromising the identity of the user (victim).

### BRIEF SUMMARY OF THE INVENTION

ProtectEM is a mobile application whose main functions are (a) To call 911 on behalf of the victim in circumstances of a physical attack where the victim's ability to call for help has been compromised. (b) To direct 911 responders to the scene of the attack through location services in the app (GPS, Google Map, etc.) (c) To record audio video, or take pictures of the attack in progress so as to give responders a clearer idea of the nature of the attack before getting on the scene.

GPS-enabled watches and other wearable accessories are already in existence (as can be seen in investigative movies like 007), but this technology is not yet available to the masses. Although initially intended for use by victims of domestic abuse, ProtectEM and the wearable accessories described in this specification are intended for mass production and civilian use (to be purchased by anyone who lives, works, or approaches risky situations and desires personal protection).

Families, employers, and loved ones can enjoy the safety of knowing that those they care about can be better protected from those in society who are poised to prey on innocent, unsuspecting individuals. By embedding the app into wearable fashion and other accessories, this makes the embedded 911 service available wherever the potential victims are (since these are items that are worn every day). This adds a level of discreteness when contacting 911, so that the attacker would be unaware of the communication going on between the victim and the 911 service responders, thus ensuring an extra level of protection for the victim in the process.

### BRIEF DESCRIPTION OF THE SEVERAL VIEWS OF THE DRAWING

FIGS. 1A and 1B show the initial configuration of the app (ProtectEM) after installation to the mobile device (phone, laptop, tablet, iPod, etc.). The questions allow new users to configure the app to their personal preferences, giving them options to choose the word or phrase they will feel comfortable to say when activating the app to call 911. Users are allowed to insert the telephone numbers of relatives or friends that they would like to send an alert to in case of an emergency. The app would automatically send them a text message alerting them that the user (or wearer of the accessory is in danger.

FIG. 1C shows the confirmation screen indicating that configuration has been completed successfully.

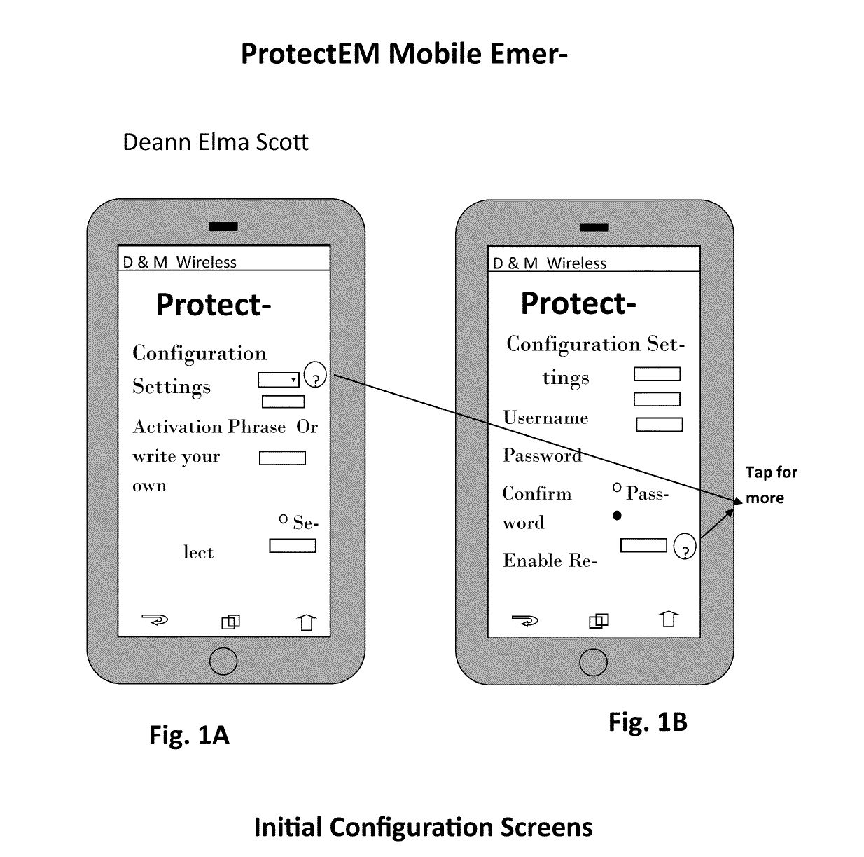

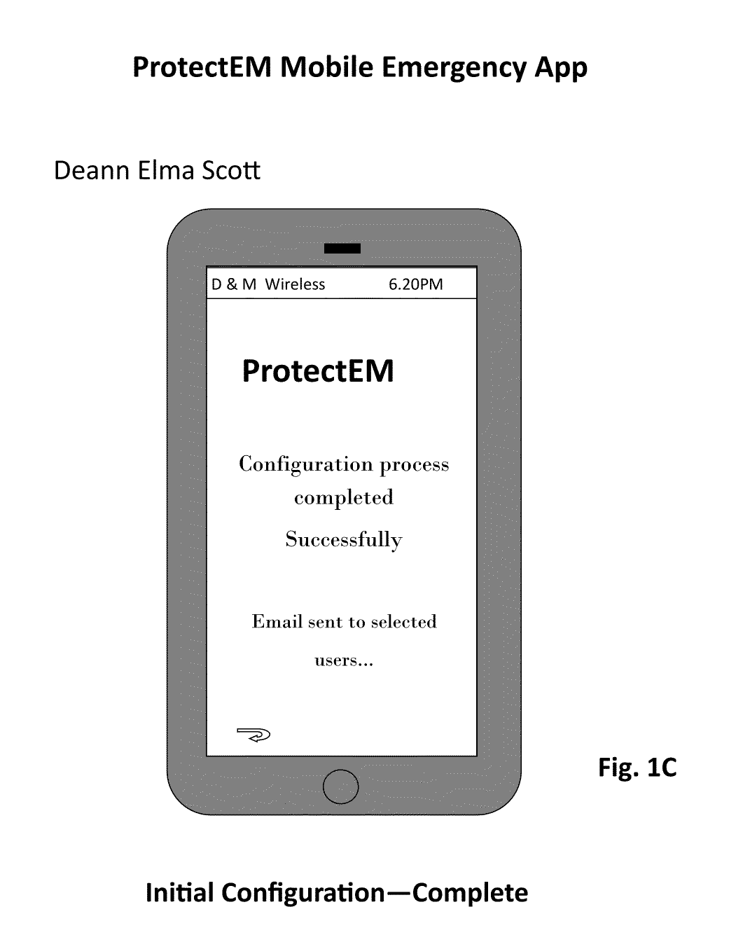

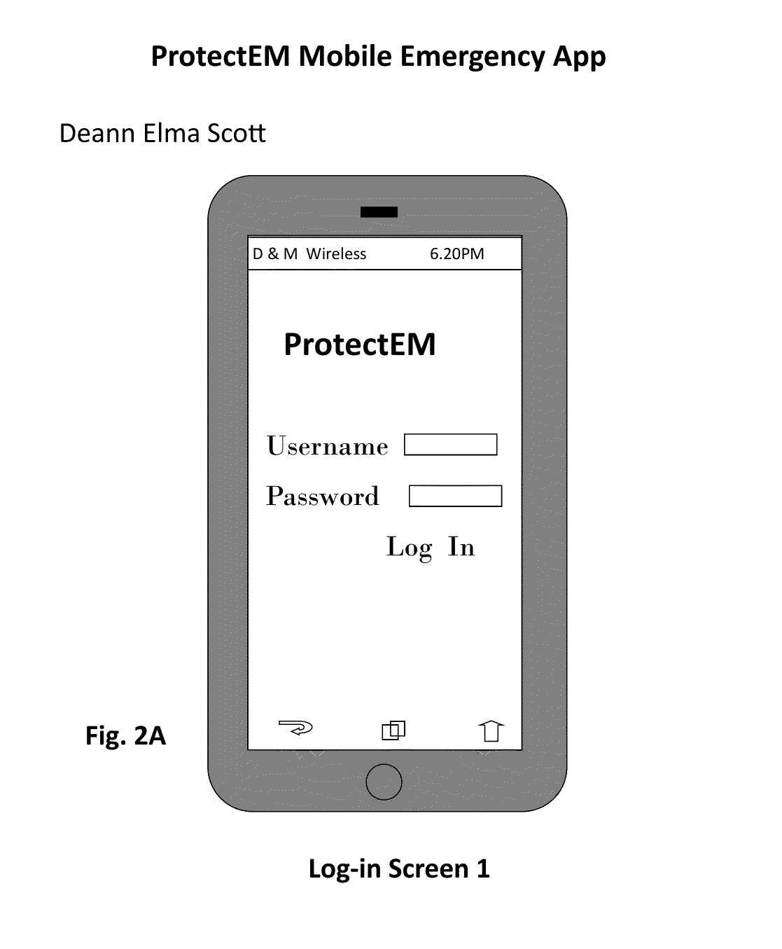

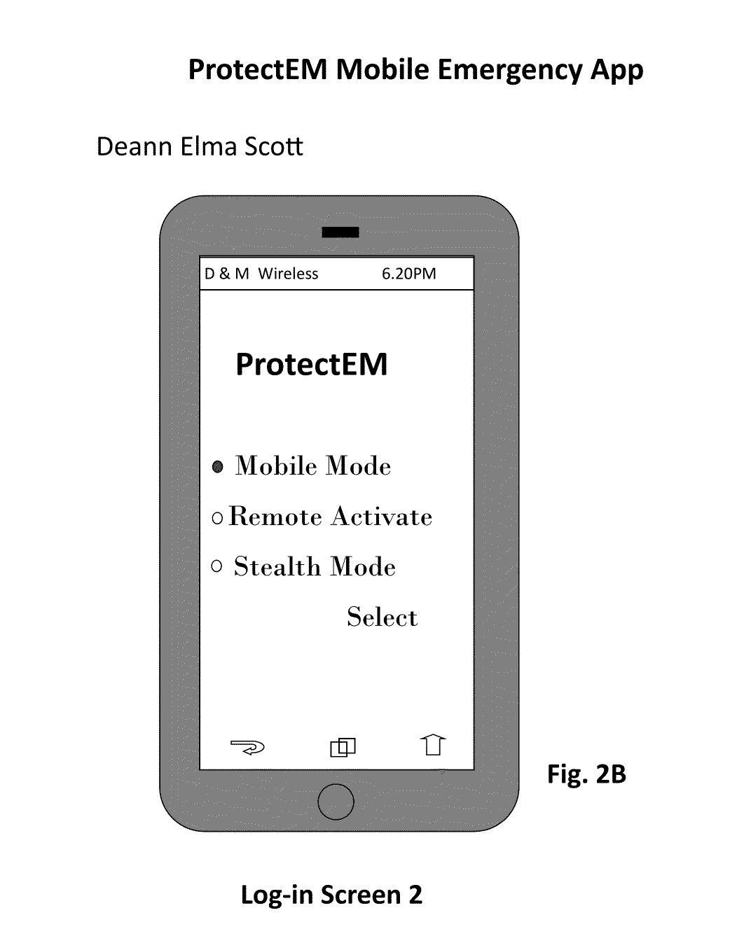

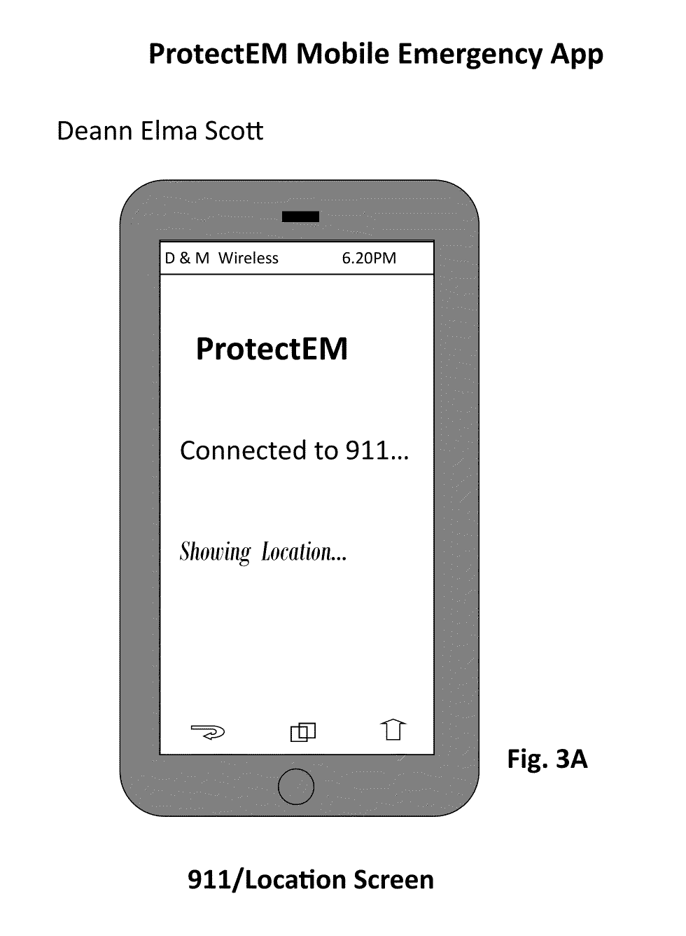

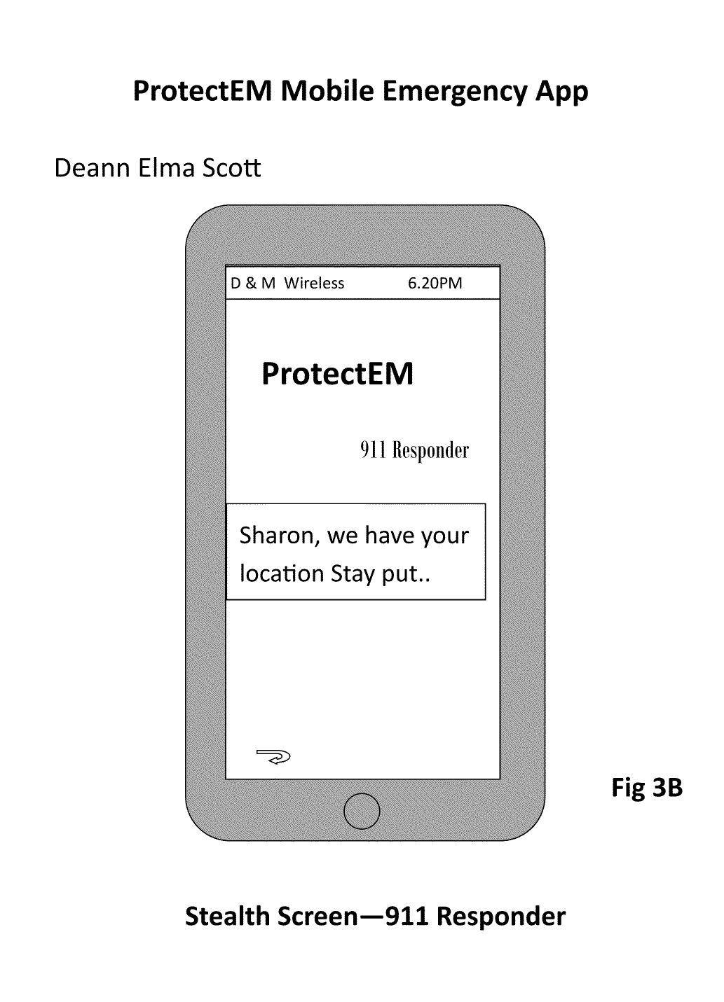

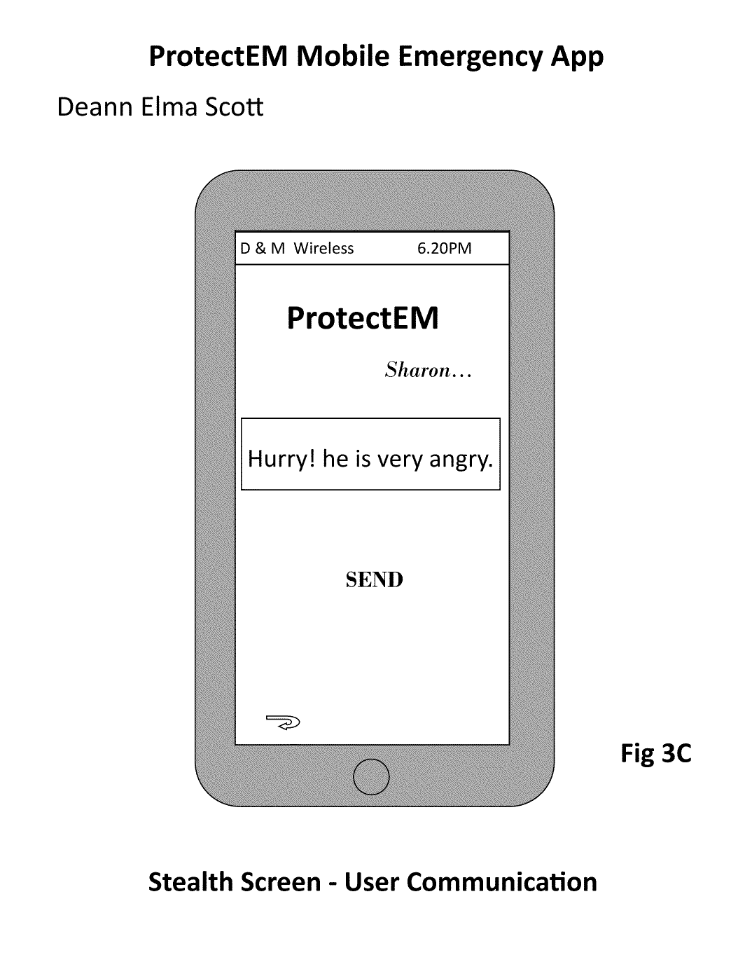

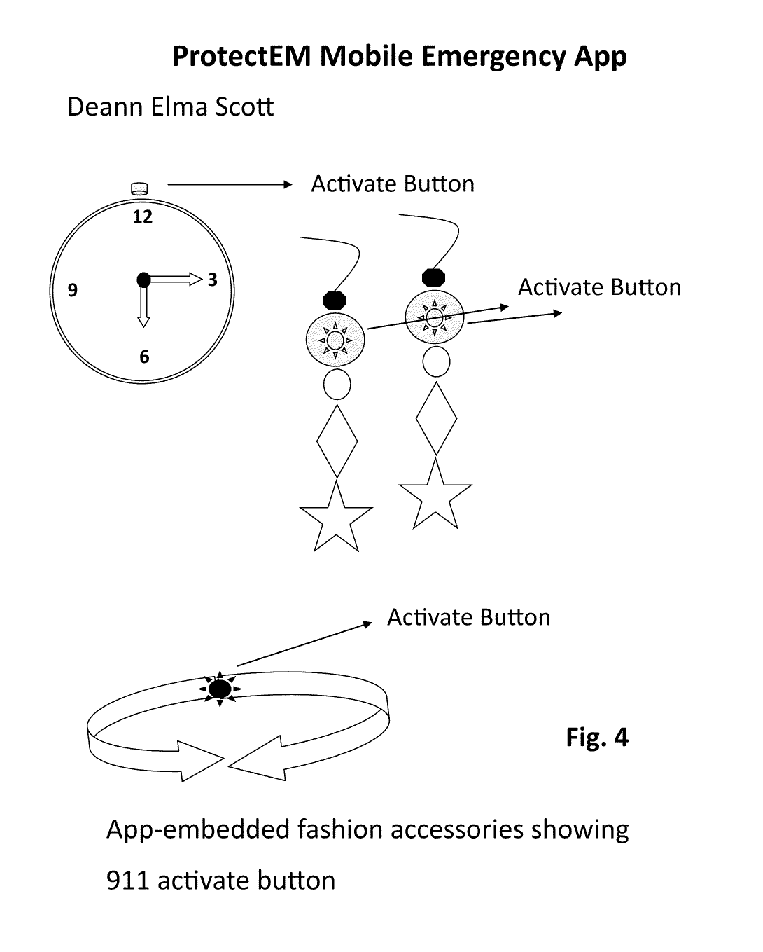

The configuration screen allows the user the ability to authorize a friend or family member to activate the app remotely if the user goes missing or is suspected to be in danger and has not activated the service. This can be necessary in the case of a young child or elderly person or mentally ill person who is unable to do so cohesively. The user's logging information is required at that time to allow for proper authentication when changing settings. After submitting the configuration information, an email message is sent to the user and the person(s) he authorized to remotely activate the service, with an email confirmation link and log in key.

FIG. 2A shows the log in screen requiring a username and password. FIG. 2B shows the options Screen. When the user logs into the app he/she is provided with three options for access. Users can log in (1) Mobile Mode (2) Stealth Mode and (3) Remote Activate Mode (as described in the detailed description below.

FIG. 3A shows the app connecting to 911. When connection is established with a 911 responder, a Star icon appears at the top of the screen. The app then automatically begins to show the user's location to the 911 responder, then switches to listening mode, muting all keyboard and other sounds including all incoming calls (Incoming calls can be seen on the screen, but can be answered with text which converts to speech on the other end). It is then able to record audio and video or take pictures of the immediate environment to give Emergency Responders a better idea of the nature of the attack.

FIG. 3B shows 911 Responder in contact with the victim in stealth mode. FIG. 3C shows the victim communicating with a 911 Responder in stealth mode.

Finally, FIG. 4 shows app-enabled fashion accessories, indicating the activate button. The activate button allows the wearer of the accessory to call for help by pressing it. This then activates the app and switches to communication mode, allowing it to record audio, and takes video or pictures of the surrounding so as to give the responder a clearer idea of the attack situation.

### DETAILED DESCRIPTION OF THE INVENTION

This invention features a mobile app designed to protect and empower victims of domestic violence, rape, and other forms of abuse, and is intended to help reduce the risk of death or serious harm as a result of such violent acts. The app (ProtectEM) will use location features (GPS, Google maps, and/or any other location technology available to mobile devices, to show the location co-ordinates and precise street address of the victim to 911 responders when activated. It will be activated in one of three ways: (1) by the user's voice (2) by the press of a button (3) remotely by logging into the app.
(1) By the users' voice: Voice-Activated-Dialing (VAD) will be built into the app by using any VAD technology available (example Nano-technology, Google Glass, nuance technology, etc.). When the user first installs the app, he will be presented with the options to configure the emergency settings to his/her personal requirement. He/she will have the option to choose the word or phrase he will say in an emergency, to activate the app (detailed instructions will be given to help users configure the settings properly). A list of pre-configured words and phrases will be built into the configuration settings for the user to choose from (words like “Stop!, Oh God, You're hurting me,” etc.). A text box will be included as an alternative option for the user to insert his/her own preferred word or phrase.
(2) By the press of a button: As a derivative product, the app will be embedded into wearable products and fashion accessories, such as earrings, necklaces, skin patches, electronic tattoos, etc. so that it can be discretely worn by the user at all times. In an attack situation, the user can discretely call 911 and immediately start revealing his/her location to Emergency Responders by pressing an easily accessible button in the accessory. Once successfully activated, the accessory will quietly begin to vibrate as it makes the 911 call and begin sending location information to first responders.
(3) Remote activation: In cases where the user (victim) wearing the device is unable to activate it in an attack situation, it can be remotely activated by a relative, care-taker, friend, etc., to see the victim's location and alert 911. In situations such as: someone going missing, an elderly or child being lost or kidnapped, the aftermath of a national disaster, rescue endeavor, etc., an individual authorized to remotely activate the app can log into ProtectEM (via web or mobile device) to do so.

ProtectEM, in addition to its built-in voice-activated dialing and location services, will provide victims with helpful information on the dynamics of domestic abuse, sexual abuse, child abuse etc. It will outline available institutions and agencies that provide assistance to victims, and provide information on how to preserve evidence following a rape situation. It will also outline available sources of counseling (spiritual and otherwise); and will list all available sources of help to the habitual abuser, to help him/her understand and overcome the violent urge for power and control. ProtectEM is intended to provide 360 degree protection—from information empowerment to 911 protection to 24/7 alert/surveillance.

### Wearable Accessaries

The application is intended to be embedded into wearable fashion accessories such as earrings, watches, necklaces, etc. Other items could include clothing items, skin patches, electronic tattoos and in home medical monitoring devices among others. By embedding the app into these everyday items, protection can be available instantly—anywhere and anytime.

Wearable fashion pieces with this capability have already been invented and in use, by a restricted group, possible people in the secret service and law enforcement, but not widely available to the mass public. ProtectEM is a civilian app, and intended for use by ordinary citizens everywhere. Currently, it is available for free download on iTunes and Google Play, but is intended to run on all mobile platforms.

### How It Is Used

As a mobile app: It can be downloaded from the app stores and installed on any mobile device from which the user can access the educational and informational data available to victims of various forms of abuse. It is currently available in this form, but the above mentioned VAD and location services will be available in later versions of the app.

As an embedded app: When embedded as a security device, it would provide instant access to 911 services as soon as it is activated by the user. As mentioned above, ProtectEM will be embedded into a smart chip which will then be embedded into to fashion accessories, clothing, and any other wearable devices for everyday protection. Embedded devices carry a unique id which must be configured into the app to synch the wearer (user) with that particular device.

To activate an accessory, the user must press a designated area on the accessory (ring, watch, clothing, etc.). It should give an initial 3 quick pulse which indicates that it is calling 911. When 911 is contacted, the accessory will begin to vibrate quietly. At this time, relatives whose phone numbers were configured into the app, would receive a text alert indicating that the wearer is in possible danger.

At this time, the accessory will switch to listening mode, sending location coordinates, audio, and taking photo shots of the surrounding (and possibly the attacker), sending this data to 911 responders, thus giving them a clearer idea of the nature of the attack.

In Stealth Mode: When fully developed, the app would be capable of being used in stealth mode via a mobile phone or other mobile devices. In an attack scenario where the user (victim) is temporarily out of sight of the attacker, the user can activate the app manually and communicate by instant messaging. The app can then be set to take shots of the onsite environment to give responders a better idea of the attack environment, while showing responders the exact location of the victim (by street and building).

When Stealth Mode is selected, the app automatically calls 911 and opens up to a text-only interface. When connected, user sees a “star” icon on the screen and can then communicate with a 911 responder via text or via code. If user is wearing a ProtectEM accessory, it will vibrate silently (confirming that connection with 911 is successful). All keyboard and other sounds would then be muted and the options of selecting coded answers gives responders a clearer idea of the nature of the emergency. See FIGS. 3B and 3C for details.

Discreteness: In any violently abusive situation, the attacker is usually the one with power and control over his/her victim. He/she does not wish his victim to gain control by calling for help, neither does he want his identity to be revealed. By the victim attempting to make a 911 call, this will off-set the balance of power and would anger the attacker, further puffing the victim in greater danger of death or serious harm. By discretely activating an app to do the calling and communication with First Responders (on behalf of the victim), the attacker is quietly being disarmed of his power and control, while minimizing the degree of harm he/she is able to inflict on the victim before Emergency Responders arrive on the scene.

### Configuring the APP

When the app is first downloaded from the app store, a c configuration page will be presented to the user with configurable options for how the app will be activated in an emergency. Options for voice-activated-dialing will include suggested words or phrases to choose from (words like “Oh God! Stop! You're hurting me!” etc. or a text box will be available for the user to insert his choice of word or phrase.

Users will then be prompted to choose whether they want to alert relatives or friends when 911 have been activated (yes or no). If ‘yes’ they will then be prompted for the phone number(s). An SMS alert will be sent to these numbers alerting the selected persons that the user is in possible danger and that 911 have been notified.

All that information should be sent to a secure database where (a) the police (b) the Emergency Room (c) and Ambulance can respond to with voice (IVR) capability.

Later, the app will be fully developed to utilize Voice-activated-Dialing (VAD) and location services, and will be embedded into the above mentioned fashion accessories to be used by people everywhere.
1. When ProtectEM is activated, (in stealth, remote activate, or accessory mode), it will automatically dial 911 on behalf of the victim (user). When connected to 911 it would automatically begin to show the user's exact location (street, building, etc.,) to Emergency Responders. It would also show the user's name, age and sex, and a photo of the victim (user) if one was uploaded during the initial configuration. However, configuration settings can be updated at any time.
2. The configuration settings can be enhanced with social Face book-like features (that will remain private) and could only be seen by the 911 Responders taking the call. When activated in stealth mode, the app automatically changes to listening mode and mutes all keyboard and other sounds (including the ring of any incoming call) to avoid compromising the victim's position, and to keep the abuser unaware of the communication between the victim and 911 responder. However, the user can see “Incoming Call . . . ” on the screen and can respond with text that translates to speech on the other end, or he/she can ignore the call. In listening mode, the app would record audio and take video or still photos of the immediate environment, to give responders a better idea of the nature of the attack.

1. ProtectEM is a mobile emergency app that makes 911 responders available to victims of domestic violence, rape, kidnapping, and other forms of violence, by automatically dialing 911 on behalf of the victim, through Voice-Activated-Dialing, location services, audio and video recording, and still picture capture, so as to minimize the risk of severe harm to the victim, bringing emergency responders to the scene of the violence at the earliest possible time, thus minimizing severe physical harm to the victim or loss of life.

2. The app can be incorporated into various wearable accessories, including but not limited to the following: rings, earrings, watches, necklaces, skin patches, or subcutaneous insertion of monitoring, security, or healthcare devices, etc., to provide protection of vulnerable persons.

3. As stated in claim 2, the Emergency Application, when embedded into any wearable accessory, the wearer (or user) is able to activate the app by pressing a button in the accessory, or by crying out a word or phrase that was pre-configured into the app, to activate the 911 response.

4. As explained in claim 2, the app can be embedded into consumer products, military and law enforcement gear, healthcare monitoring devices, and more.

5. As part of the location service features outlined in claim 1, when activated, the app is able to pin-point the victim's (or user's) exact location to emergency personnel, enabling them to quickly locate and rescue the victim, while he/she is actively subjected to the attack, thus helping to minimize the risk of severe harm to the victim by bringing 911 responders to the scene of the attack as soon as possible.

6.

7. The protection referred to in claims 3 to 5 can be accomplished in the following ways:
(a) In stealth mode
(b) By pressing a smart button on the wearable accessory or device, the wearer can discretely activate the app to call 911 and at the same time, alert relatives and friends that the wearer is in danger.
(c) By saying a (pre-configured) word or phrase—the app would be activated to call 911
(d) Accessory mode and
(c) Remote Activate Mode.

8. According to claim 7 in Remote Activate Mode, If the wearer (victim) is unable to activate the app, (as in the case of a very young child, an elderly person, mentally ill, or unconscious person; or in the case of a kidnapped or missing person, the app can be activated remotely by a family member or other person once that individual was given permission during app configuration, to activated the app remotely being able to contact 911 on behalf of the victim, thus revealing the victim's location, and taking snap shots of the person's environment.

9. As re-enforced in claims 7, the app (ProtectEM) can be activated in Stealth Mode, Remote Activate Mode, or in Accessory Mode, and it will put through a call to 911 on behalf of the victim (user) but also, when connected to 911 it would automatically begin to show the user's exact location (street, building, etc.,) to Emergency Responders.

10.

11. As stated in claim 8 when activated in stealth mode, the app automatically changes to listening mode and mutes all keyboard and other sounds (including the ring of all incoming call), to avoid compromising the victim's position, and to keep the abuser unaware of the communication between the victim and 911 responder, while allowing the user to see any “Incoming Calls” on the screen and can respond with text that translates to speech on the other end.

12. According to claim 11, when in listening mode, the app would record audio and take video or still photos of the immediate environment, to give responders a better idea of the nature of the attack.

13. ProtectEM is intended to provide 360 degree protection—from information empowerment, to 911 protection, to 24/7 alert/surveillance, and must be available on all mobile platform.

14.

15. According to claim 2, to activate an accessory, the user must press a designated area on the accessory (ring, watch, clothing, etc.) which will give an initial 3 quick pulse, indicating that it is calling 911, after which the accessory will begin to vibrate quietly and at which time, relatives whose phone numbers were configured into the app, would receive a text alert indicating that the wearer is in possible danger.

16.

17. As featured in claim 2 when Stealth Mode is selected, the app automatically calls 911 and opens up to a text-only interface. When connected, user sees a “star” icon on the screen which indicates that they can then communicate with a 911 responder via text, and If user is wearing a ProtectEM accessory, it will vibrate discretely, confirming that connection with 911 Responders is successful, so at this time, all keyboard and other sounds would then be muted automatically, and the options of selecting coded answers will give responders a clearer idea of the nature of the emergency.
